(19) United States
(12) Patent Application Publication
(10) Pub. No.: US 2019/0263299 A1
(43) Pub. Date: Aug. 29, 2019

(54) PROCESS TO MOLD 3-DIMENSIONAL LEATHER TRIM COVER

(71) Applicant: Magna Seating Inc, Aurora, AS (US)

(72) Inventor: Eric Kozlowski, Oakland Township, MI (US)

(21) Appl. No.: 16/283,930

(22) Filed: Feb. 25, 2019

Related U.S. Application Data
(60) Provisional application No. 62/634,218, filed on Feb. 23, 2018.

(51) Int. Cl. B60N 2/58; B68F 1/00

(52) U.S. Cl. CPC B60N 2/5891; B68F 1/00

(57) ABSTRACT

A seat trim cover for an automotive seat formed from milled leather which lacks coatings and/or paint on the milled leather while retaining stored elongation introduced to the leather fiber structure during a milling process. At least one coating and/or paint is applied to an upper surface of the 3-dimensional leather shape after the milled leather is formed into a 3-dimensional leather shape by one or more of a vacuum form process, a compression mold process, and/or an embossing process.

### CROSS-REFERENCE TO RELATED APPLICATIONS

This application claims priority to and all the benefits of U.S. Provisional Application No. 62/634,218, filed on Feb. 23, 2018, which is incorporated by reference herein.

### BACKGROUND OF THE INVENTION

### 1. Field of the Invention

The present invention relates to a formed leather trim cover having a 3-dimensional shape. More particularly, the invention relates a process for forming a 3-dimensional leather shape out of milled leather and an automotive seat trim cover formed from milled leather.

### 2. Description of Related Art

Various processes for forming 3-dimensional leather shapes are known in the art. One known process for making a 3-dimensional leather component comprises cutting one or more pieces of finished leather and sewing the pieces together forming one or more seams to achieve a desired 3-dimensional shape. In a second known process, tanned finished leather is softened by humidifying or soaking the leather prior to placing the softened leather into a compression mold to form a 3-dimensional leather shape. Another known process comprises heating the finished leather to between 150° C.-200° C., placing the heated leather on a surface of a vacuum form mold, vacuum forming the heated leather between 350 mmHg to 700 mmHg, and cooling the formed leather.

However, these known processes are complex, requiring preheating and/or prewetting the finished leather prior to the molding or forming step. Also, other known processes requiring cutting and sewing leather pieces together may result in multiple sewing seams. Further, sewn leather shapes may have seams in undesirable locations, may create an undesirable appearance, and may have reduced performance in use due to the multiple seams.

It is desirable, therefore, to form 3-dimensional leather shapes without preheating and/or hydrating the leather prior to a forming process. It is also desirable to have a 3-dimensional leather shape lacking sewing seams. Further, it is desirable to form leather seat trim covers with less seams for use in automotive vehicles. Finally, it is desirable to form seat trim covers with an increase in contour and/or detailed shapes while minimizing the number of seams.

### SUMMARY OF THE INVENTION

A seat trim cover for an automotive seat formed from milled leather which lacks coatings and/or paint on the milled leather while retaining stored elongation introduced to the leather fiber structure during a milling process. At least one coating and/or paint is applied to an upper surface of the 3-dimensional leather shape after the milled leather is formed into a 3-dimensional leather shape.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 illustrates a perspective view of a 3-dimensional leather shape according to an embodiment of the present invention;

FIG. 2 is a flow chart illustrating commonly known hide processing steps and production of 3-dimensional leather shapes;

FIG. 3 is a flow chart illustrating hide processing steps and production of 3-dimensional leather shapes from milled leather according to an embodiment of the present invention;

FIG. 4 illustrates a perspective view of a milled leather hide according to an embodiment of the present invention;

FIG. 5 illustrates a perspective view of the milled leather hide of FIG. 4 which has been cut into a leather blank according to an embodiment of the present invention;

FIG. 6 illustrates a perspective view of the leather blank of FIG. 5 assembled onto a forming mold according to an embodiment of the present invention;

FIG. 7 illustrates a perspective view of the leather blank of FIG. 6 after a forming process according to an embodiment of the present invention;

FIG. 8 illustrates a perspective view of the formed leather blank of FIG. 7 after a coating process according to an embodiment of the present invention; and

FIG. 9 illustrates a perspective view of an automotive seat according to an embodiment of the present invention.

### DETAILED DESCRIPTION OF THE EMBODIMENTS

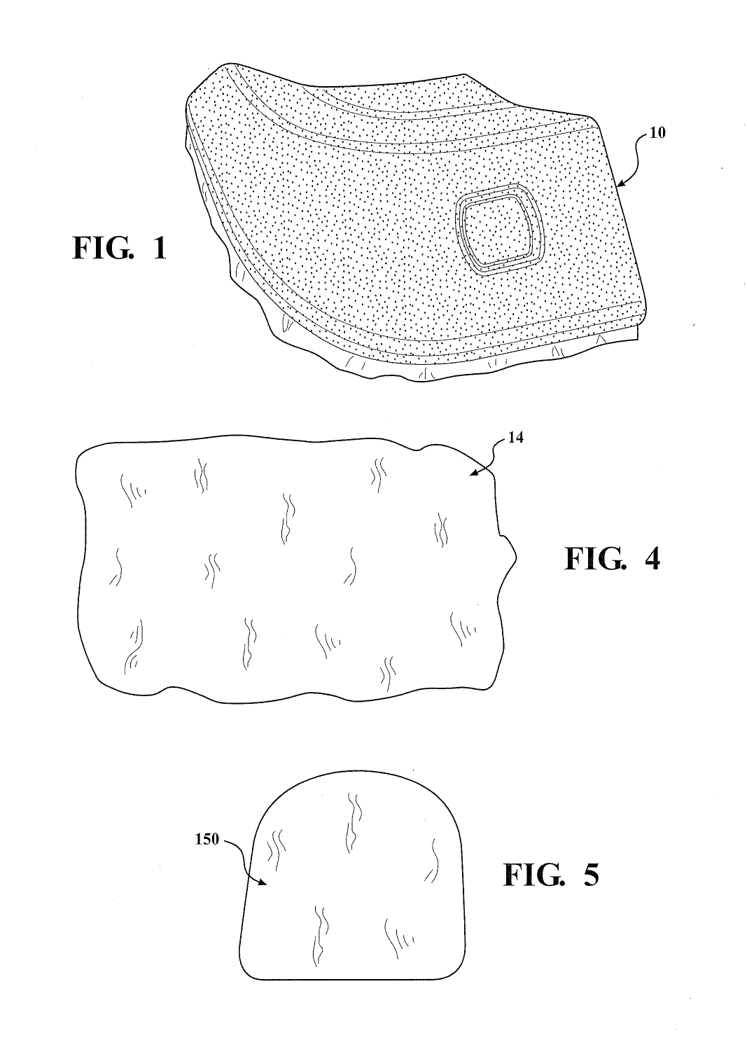

FIG. 1 and FIGS. 3 to 9 illustrate a process of forming 3-dimensional leather shapes according to embodiments described herein. Directional references employed or shown in the description, figures or claims, such as top, bottom, upper, lower, upward, downward, lengthwise, widthwise, left, right, and the like, are relative terms employed for ease of description and are not intended to limit the scope of the invention in any respect. Further, the Figures are not necessarily shown to scale. Referring to the Figures, like numerals indicate like or corresponding parts throughout the several views.

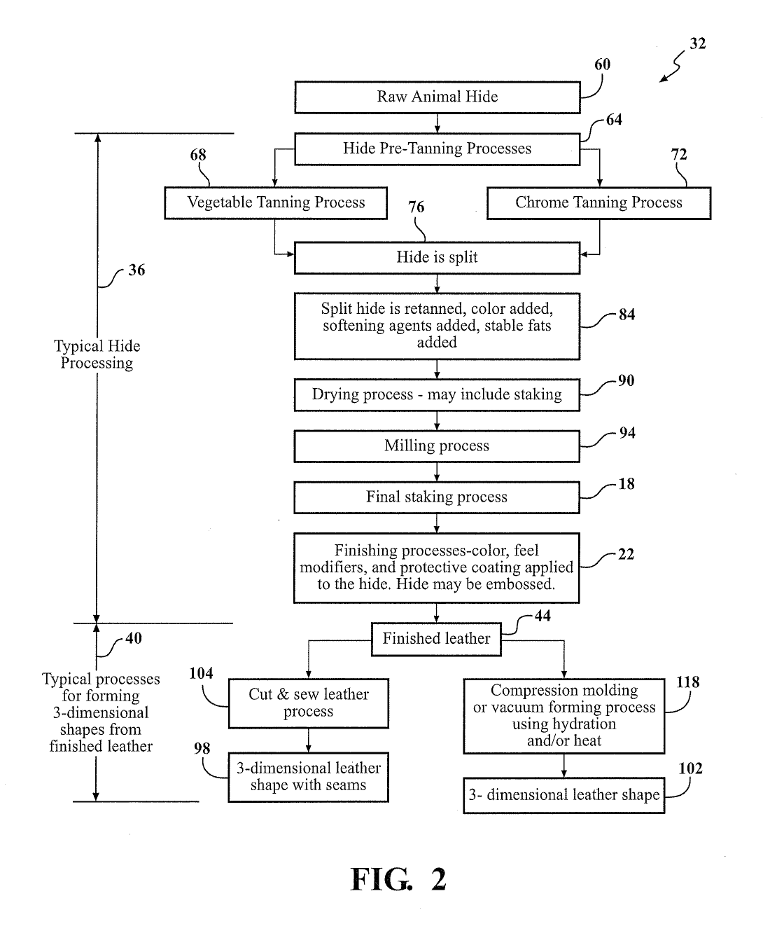

FIG. 1 illustrates a perspective view of a formed 3-dimensional leather shape 10 which has been molded by a forming process using milled leather hides 14 in which certain typical leather processing steps were omitted in the hide processing. The omitted leather processing steps are final staking 18 of the hide 14 and finishing the hide 14 by applying paint or coatings 22 to the hide 14, as illustrated in FIG. 2 described below.

FIG. 2 illustrates a general flow chart 32 of typical hide processing steps 36 as well as commonly known processes for forming 3-dimensional leather shapes 40 from finished leather 44. Typically, raw animal hides 60 pass through pre-tanning processes 64 and then through a first tanning process 68, 72. A vegetable tanning process 68 or a chrome tanning process 72 is used to produce vegetable tanned leather 68 or chrome tanned leather 72, respectively, using methods generally known in the art. The chromed tanned leather 72, referred to as “wet blues”, has undergone the tanning process 72 containing chrome. The vegetable tanned leather 68, referred to as “wet whites”, is tanned with a chrome-free process 68. Both types of tanned leather 68, 72 are split 76 into two pieces by separating the hair follicle side from the flesh side of the hide 60. The flesh side of the tanned leather 68, 72 is referred to as “drop split”. The hair follicle side of the tanned leather 68, 72 is referred to as “top grain split” and is generally used to make better grades of finished leather 44. After splitting, each side of the split leather hide 76 is retanned using the processing steps at 84 to add color to the leather hide 76, add softening agents, add stable fats to replace natural animal fats removed during the tanning process, and add other additives to improve the leather hide properties.

The retanned split leather hides 84 are dried 90 to remove most of the moisture from the hides 84. The method used to remove most of the moisture from the hides 84 affects the properties of the finished leather 44. The hides 84 can be hung on hooks and the moisture allowed to evaporate naturally. Air drying hides 84 can result in shrinkage of about 25% and produces leather that can stretch in a limited range without tearing. A second known method is oven toggle frame drying in which the hides 84 are clipped to a frame (not shown) to minimize shrinkage during drying and then exposed to elevated temperatures to speed the moisture evaporation. This results in leather that has limited elongation within the fiber structure and less shrinkage when compared to air dried hides 84. Another commonly known drying method is vacuum drying which also results in minimal shrinkage as well as minimal elongation stored within the fiber structure of the hide 84.

Mechanical staking can be added during the drying process 90 and/or as a final staking step 18 after the drying process 90 to increase the hide size. A typically known mechanical staking process is a mechanical beating action provided by a machine to soften and stretch the hide 84. Generally, the hide 84 is staked while the hide 84 has sufficient moisture content to tolerate the stretching that occurs during the staking operation. Typically about 10% increase in hide surface area can be obtained by staking the hide 84 during the drying process 90. An exemplary staking process is described in U.S. Pat. No 7,047,665B2 in which hides 84 having a relative moisture content about 45% to about 65% are passed through a staking machine (not shown) having beating plates (not shown) to impart localized mechanical stresses on the hide 84 to stretch the hide 84. Optionally, the relative moisture content in the hides 84 may be reduced below 45% and the staking process 18 repeated to further stretch the hide 84. The relative moisture content in the hide 84 is further reduced to about 7% to 15% which results in a stiff dried hide 84.

To soften the hides 84, the hides 84 are milled in a tumbling process 94 to break up and relax fibers in the hide. The milling process 94 can shrink the hide 84 and reduce surface area by about 10%. The shrinkage in the hide 84 during the milling process 94 induces about 10% elongation or residual stretch into the hide fiber structure. The staking process 18 is repeated after milling 94. The staking process 18 stretches the hide 84 back to about the original size or larger depending on the amount and degree of staking 18. However, the final staking process 18 removes most or all of the residual stretch from the hide structure that was induced during the milling step 94. The more the hide 84 is stretched in the final staking process 18, the less residual stretch remains in the hide 84.

The staked hides 84 are then put through finishing processes 22 where paint is applied to the hide surface. Color, feel modifiers, and protective coatings may be applied to the hide 84 during the finishing processes 22. Filler materials may be applied to the hide 84 to cover up surface defects on the hide 84. Optionally, the hide 84 may pass through a heated die process to form a specific grained look to produce an embossed grain finished hide 44. Omitting the embossing operation results in a natural grain finished hide 44 which has the appearance of the natural grain as determined by hair follicles present in the hide 44. Painting and optionally embossing the hide 44 locks the hide 44 into a specific shape and size for the life of the hide 44. Once the hide 44 goes through these typical finishing processes 22, the amount of residual elongation remaining the in the hide 44 is about 2-5%. Finished hide 44 is cut or trimmed into usable pieces and referred to as “leather” or “finished leather” 44. However, hides 60 which have partially passed through various steps of typical hide processing may also be referred to as leather 60. Typically, leather 84 which has undergone final staking process 18 after a milling process 94, and further has undergone finishing processes 22 to add paint or a coating to the leather 84 is referred to as “finished leather” 44.

A variety of known processes 40 used to form 3-dimensional shaped leather pieces 98, 102 are also shown in FIG. 2. One known process of forming a 3-dimensional leather shape 98, such as a seat cover assembly, comprises a step 104 of cutting flat shapes out of finished leather 44 using 2-dimensional cutting dies (not shown). Several pieces of cut finished leather 104 are sewn together to form the 3-dimensional leather shape 98. Highly contoured 3-dimensional leather shapes 98 require multiple leather pieces 104 and result in multiple sewn seams. The amount and placement of seams affects the overall appearance and performance of the 3-dimensional leather shape 98.

Another known process 118 of forming a 3-dimensional leather shape 102 is to vacuum form and/or compression mold a cut piece of finished leather 44 that has been hydrated prior to the forming operation. Hydrating the finished leather 44 increases the amount the finished leather 44 can be stretched without tearing. This process requires the formed leather shape 102 to be dehydrated (dried) and/or heated to remove the added moisture. Alternatively, the finished leather 44 may be pre-heated prior to and/or during the forming process 118. Combinations of hydration and heating may be used during forming operations 118 in order to produce the 3-dimensional leather shape 102 without tearing the finished leather 44.

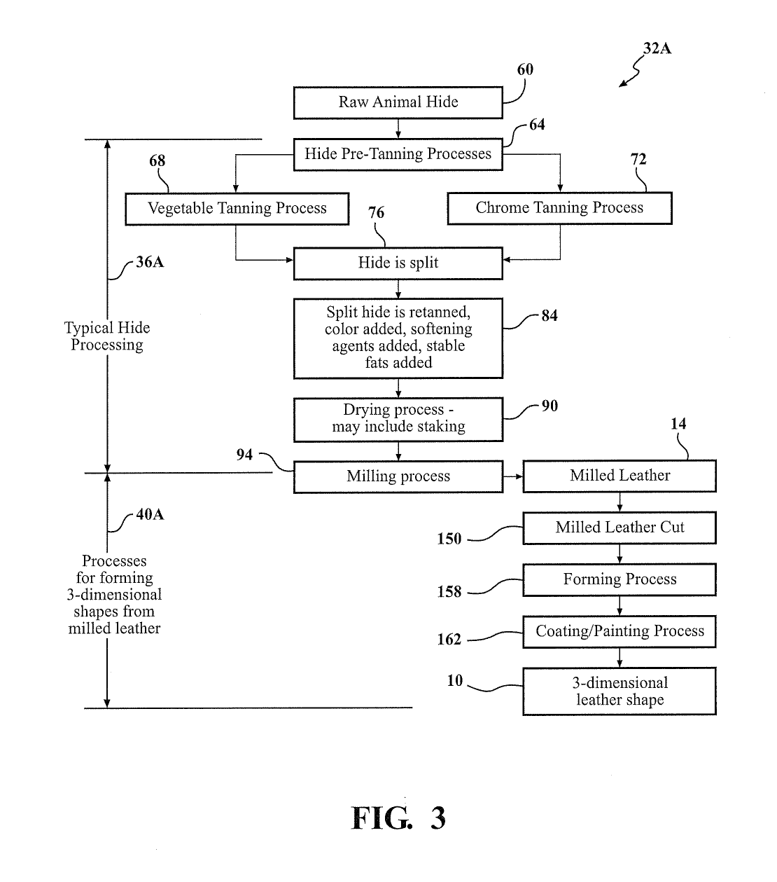

A flow chart 32A according to an embodiment of the present invention for forming seamless 3-dimensional leather shapes 10 from milled leather 14 is shown in FIG. 3 which comprises typical hide processing steps 36A though a milling process 94 followed by a process 40A for forming 3-dimensional shapes 10 from milled leather 14. Similar to the process shown in FIG. 2, a raw animal hide 60 undergoes typical pre-tanning processes 64, followed by either a vegetable tanning process 68 or a chrome tanning process 72. The tanned hide 68, 72 is split 76, the split hide 76 is retanned 84, with color, softening agents, and stable fats added to the split hide 76. The retanned split leather hide 84 undergoes typical drying processes 90 which may include a staking operation to partially stretch the split hide. The split hide 84 undergoes a typical milling process 94 to further soften the hide 84 and produce milled leather 14. In the process shown in FIG. 3, the prior processing steps of the final staking process 18 as well as the finishing processes 22, which convert the milled leather 14 into finished leather 44, are omitted. These final steps 18, 22 are omitted since once a hide 84 has been traditionally finished through these final processing steps 18, 22, the finished leather 44 has very low elongation such that it is difficult to process the finished leather 44 into a 3-dimensional shape 98, 102 without using processes such as cut & sew pieces, preheating, and/or hydrating the finished leather 44. Even when using excessive pressures and temperatures, the finished leather 44 may resist forming and may tear.

However, after the milling process 94, hides 14 typically have ≈10% elongation built in to the fiber structure due to shrinkage that occurs in the milling/tumbling operation. By using milled leather 14 instead of finished leather 44, this stored elongation permits the milled leather 14 to be formed into 3-dimensional shapes 10 without additional processing steps 104, 118 since the stored elongation allows the milled leather 14 to be formed around curved shapes.

Referring again to FIG. 3, the process 40A of forming seamless 3-dimensional leather shapes 10 further comprises steps of cutting the milled leather 14 into a leather blank 150 having a desired shape, placing the cut leather blank 150 onto a mold 154 and performing a vacuum mold and/or compression mold process 158, and coating and/or painting 162 the formed 3-dimensional leather shape 10. Once the 3-dimensional leather shape 10 is formed, paint and/or coatings are applied per generally known leather finishing processes 162. When removed from the forming tools, the leather shape 10 has very low bounce back and maintains its formed shape. Painting the leather shape 10 locks leather fibers into the final 3-dimensional shape. Optionally, a 3-dimensional compression graining tool (not shown) may be used to post-grain emboss the leather shape 10.

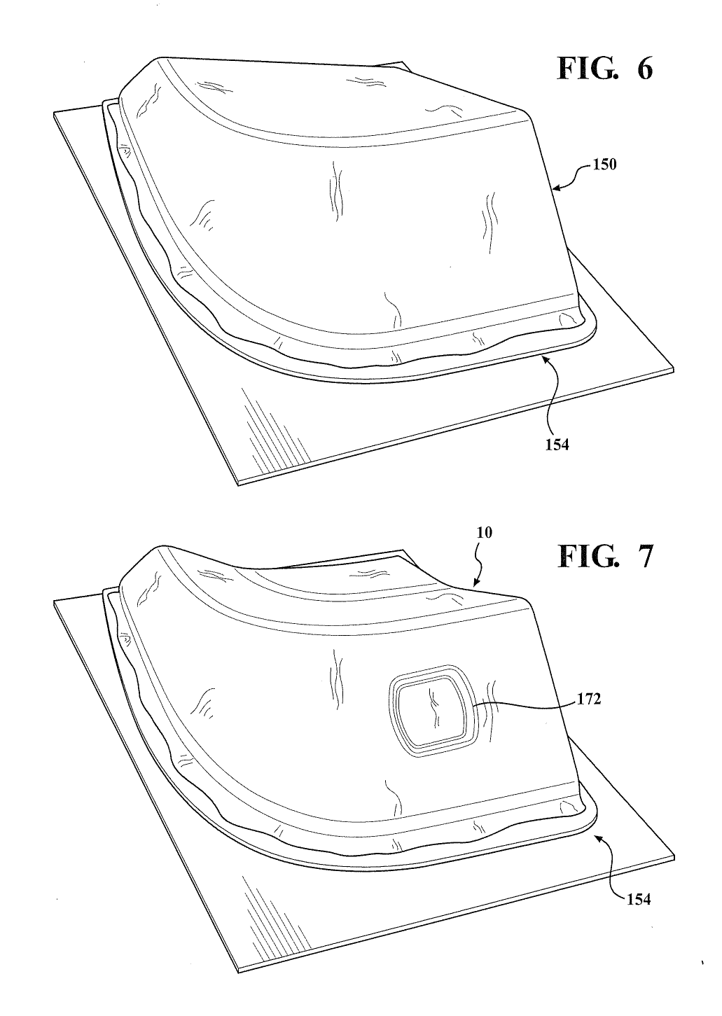

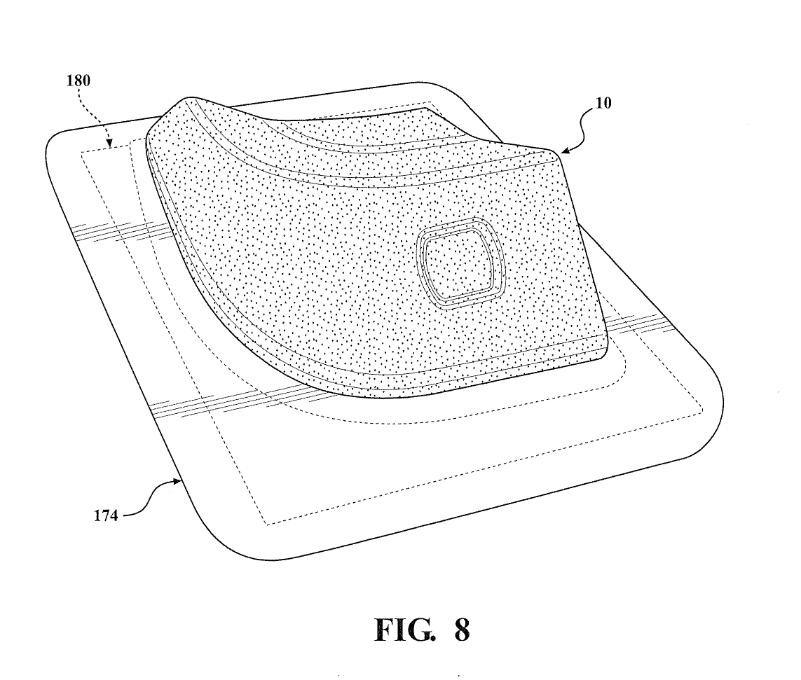

An embodiment of the process 40A for forming 3-dimensional leather shapes 10 from milled leather 14 is further illustrated in FIGS. 4-8. FIG. 4 shows milled leather hide 14. A cut leather blank 150 is shown in FIG. 5. The cut leather blank 150 is placed on a forming tool 154, as shown in FIG. 6. The formed 3-dimensional leather shape 10 is shown in FIG. 7 after a vacuum form and/or compression molding process 158. Various contoured regions 172 can be formed in the 3-dimensional leather shape 10 as desired for an intended application. FIG. 8 illustrates the edges of the 3-dimension leather shape 10 secured by upper and lower pieces 174, 180 and after paint and/or coatings are applied to the surface of the leather shape 10.

Vacuum forming and/or compression molding milled leather 14 is suitable for forming 3-dimensional leather shapes 10 for various applications such as seating, furniture, or clothing. With this process, 3-dimensional leather surfaces are achievable with minimal or no surface sewing and without requiring hydrating and/or heating the finished leather during forming of the 3-dimensional shape 10. One-piece surface materials can now be used with shapes and designs that are difficult to achieve through traditional means from finished leather 44.

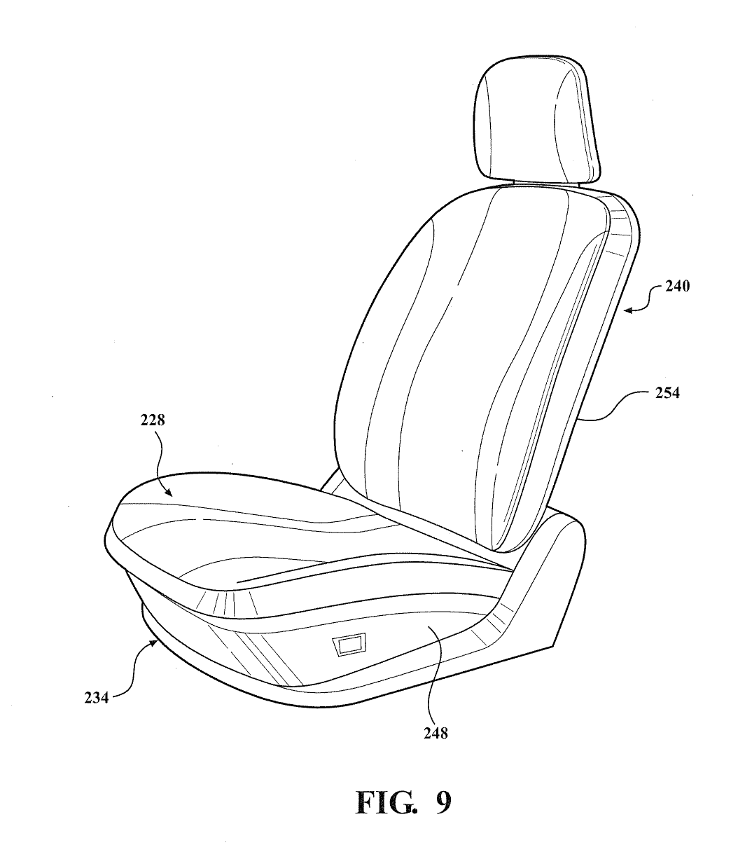

One-piece 3-dimensional leather shapes 10 made from milled leather 14 allow for a reduction and/or elimination of seams for leather seat trim covers 228 and leather trim pieces (not shown) used in vehicle interiors. Leather seat trim covers are commonly assembled by cutting pieces of finished leather 44 and sewing pieces together to form a 3-dimensional seat trim cover. Unfortunately, numerous seams may be required when cutting pieces and sewing together to form a desired 3-dimensional shape. Also, the amount of detail that can be included in the 3-dimensional shape is limited using a cut & sew method. However, when the seat trim cover 228 is formed from milled leather 14 as illustrated in FIG. 3, the seat trim cover 228 has minimal or no sewing seams in critical areas, such as shown in FIG. 9. The final leather piece 10 is trimmed after the coating and/or painting process 162 and subsequently sewn into a seat cover assembly 234. The seat cover assembly 234 is assembled as part of an automotive seat 240 and may form a portion of a seat cushion 248 and/or a seat back 254. A similar process can be used to form any piece of interior automotive trim with reduced or eliminated seams. By forming the seat trim cover 228 from milled leather 14, there is a reduction/elimination of sewing which decreases the cost of the seat cover assembly 234.

One benefit of forming 3-dimensional leather shapes from milled leather is a simplified process which does not require hydrating and/or heating the leather during a molding/forming process. A second benefit is a reduction or elimination of sewing seams on a finished 3-dimensional leather shape. An additional benefit is obtained by producing leather seat trim covers with less sewing seams. Further, more complex and increased contoured 3-dimensional leather shapes can be formed/molded from milled leather compared to typically used finished leather.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A 3-dimensional leather shape, said leather shape comprising:
milled leather lacking finish coatings and/or paint and retaining an amount of inherent elongation stored in leather fibers during a milling process;
wherein said milled leather is formed into a 3-dimensional leather shape prior to applying coatings and/or paint.

2. The 3-dimensional leather shape as set forth in claim 1, wherein said 3-dimensional leather shape has a coating and/or paint applied to an upper surface of said leather shape after said milled leather is formed into said 3-dimensional shape.

3. The 3-dimensional leather shape as set forth in claim 2, wherein said milled leather comprises greater than about 5% stored elongation in said leather fibers prior to said milled leather being formed into said 3-dimensional leather shape.

4. The 3-dimensional leather shape as set forth in claim 3, wherein said forming process is one or more of a vacuum form process, a compression mold process, and/or an embossing process.

5. The 3-dimensional leather shape as set forth in claim 4, wherein said 3-dimensional leather shape is at least a portion of a seat trim cover for an automotive seat.

6. The 3-dimensional leather shape as set forth in claim 4, wherein said 3-dimensional leather shape is at least a portion of an interior trim piece for an automotive vehicle.

7. A 3-dimensional leather seat trim cover for an automotive seat, said seat trim cover comprising:
a 3-dimensional leather shape having at least one coating and/or paint on an upper surface of said 3-dimensional shape; and
said 3-dimensional leather shape formed from milled leather lacking finish coatings and/or paint and retaining an amount of inherent elongation stored in leather fibers during a milling process;
wherein said at least one coating and/or paint is applied to said upper surface of said 3-dimensional leather shape after said 3-dimensional leather shape is formed from said milled leather.

8. The 3-dimensional leather seat trim cover as set forth in claim 7, wherein said milled leather comprises greater than about 5% stored elongation in said leather fibers prior to said milled leather being formed into said 3-dimensional leather shape.

9. The 3-dimensional leather seat trim cover as set forth in claim 8, wherein said forming process is one or more of a vacuum form process, a compression mold process, and/or an embossing process.

10. A method of forming a 3-dimensional leather shape, said method comprising:
providing milled leather lacking finish coatings and/or paint and retaining an amount of inherent elongation stored in leather fibers during a milling process;
cutting a leather blank from said milled leather;
forming said leather blank into a 3-dimensional leather shape; and
applying at least one layer of a coating and/or a paint to an upper surface of said 3-dimensional leather shape.

11. The method of forming a 3-dimensional leather shape as set forth in claim 10, further comprising:
forming said leather blank into said 3-dimensional leather shape by one or more of a vacuum form process, a compression molding process, and/or an embossing process.

12. The method of forming a 3-dimensional leather shape as set forth in claim 11, further comprising:
providing milled leather having greater than about 5% stored elongation in said leather fibers prior to said milled leather being formed into said 3-dimensional leather shape.

13. The method of forming a 3-dimensional leather shape as set forth in claim 12, further comprising:
trimming said 3-dimensional leather shape.

14. The method of forming a 3-dimensional leather shape as set forth in claim 13, further comprising:
assembling said 3-dimensional leather shape as at least a portion of a seat trim cover for an automotive seat.

15. A method of forming a 3-dimensional leather seat cover for an automotive seat, said method comprising:
providing milled leather lacking finish coatings and/or paint and retaining an amount of inherent elongation stored in leather fibers during a milling process;
cutting a leather blank from said milled leather;
forming said leather blank into a 3-dimensional leather shape;
applying at least one layer of a coating and/or a paint to an upper surface of said 3-dimensional leather shape;
trimming said 3-dimensional leather shape; and
assembling said 3-dimensional leather shape as at least a portion of a seat trim cover.

16. The method of forming a 3-dimensional leather seat cover as set forth in claim 15, further comprising:
providing milled leather having greater than about 5% stored elongation in said leather fibers prior to said milled leather being formed into said 3-dimensional leather shape.

17. The method of forming a 3-dimensional leather seat cover as set forth in claim 16, further comprising:
forming said leather blank into said 3-dimensional leather shape by one or more of a vacuum form process, a compression molding process, and/or an embossing process.
